(19) United States
(12) Patent Application Publication
(10) Pub. No.: US 2009/0128567 A1
(43) Pub. Date: May 21, 2009

(54) MULTI-INSTANCE, MULTI-USER ANIMATION WITH COORDINATED CHAT

(76) Inventors: Brian Mark Shuster, Zephyr Cove, NV (US); Gary Stephen Shuster, Fresno, CA (US)

Correspondence Address: CONNOLLY BOVE LODGE & HUTZ LLP, P.O. BOX 2207, WILMINGTON, DE, 19899, US

(21) Appl. No.: 12/271,621

(22) Filed: Nov. 14, 2008

Related U.S. Application Data
(60) Provisional application No. 60/988,335, filed on Nov. 15, 2007.

(51) Int. Cl. G06T 13/00

(52) U.S. Cl. 345/473

(57) ABSTRACT

Two or more participants provide inputs from a remote location to a central server, which aggregates the inputs to animate participating avatars in a space visible to the remote participants. In parallel, the server collects and distributes text chat data from and to each participant, such as in a chat window, to provide chat capability in parallel to a multi-participant animation. Avatars in the animation may be provided with animation sequences, based on defined character strings or other data detected in the text chat data. Text data provided by each user is used to select animation sequences for an avatar operated by the same user.

### CROSS-REFERENCE TO RELATED APPLICATIONS

This application claims priority pursuant to 35 U.S.C. § 119(e) to U.S. provisional application Ser. No. 60/988,335, filed Nov. 15, 2007, which is hereby incorporated by reference in its entirety

### BACKGROUND

1. Field

This application relates to virtual computer-generated environments in which participants are represented by computer-generated avatars, and in particular for environments that simulate an actual 3-D environment and allow for simultaneous participation of multiple players.

2. Description of Related Art

Computer generated virtual environments are increasingly popular methods for people, both real and automated, to interact within a networked system. The creation of virtualized worlds, three dimensional or otherwise, is well known. Simple text based adventures such as “Zork”, early “first person shooter” games such as “Doom”, and ultimately numerous highly complex environments such as “Halo” are well known in the art. Various on-line environments are known in which a 3-D physical world (actual or fantasy) is simulated. Environments of this type are sometimes referred to as “virtual reality” or “virtual reality universe” (VRU) environments. In known VRU environments, an actual or fantasy universe is simulated within a computer memory. Multiple players may participate in the environment through a computer network, such as a local area network or a wide area network. Each player selects an “avatar,” which may comprise a three-dimensional figure of a man, woman, or other being, to represent them in the VRU environment. Players send inputs to a VRU engine to move their avatars around the VRU environment, and are able to cause interaction between their avatars and objects in the VRU. For example, a player's avatar may interact with an automated entity or person, simulated static objects, or avatars operated by other players.

VRU's are used to implement traditional computer gaming in which a defined goal may be sought after, or a game score kept. In traditional computer gaming, the game player is primarily interested in achieving a defined goal or score, and the game is played as a sort of test of skill of dexterity and reflexes, and/or mental ability. VRU's may also be used to implement environments that are relatively open, or free form. In a free form environment, little or no emphasis is placed on achieving a goal or achieving a high score in a test of skill, although such elements may still be present. Instead, the VRU is used as a kind of alternative reality, which can be explored and influenced. In free-form gaming, players may be primarily interested in interacting with other players via text or verbal chat, and in transacting in a virtual economy supported by the VRU. In free-form gaming, therefore, it is desirable for the VRU is to enable social interaction between the participants.

Notwithstanding their advantages, prior-art VRU's are lacking tools and capabilities whereby the VRU can provide richer and more efficient participation between remotely located participants. It is desirable, therefore to provide methods and systems to provide these and other enhancements to VRU environments.

### SUMMARY

Methods, systems and apparatus for managing multi-user, multi-instance animation for interactive play enhance communication between participants in the animation. Using the technology disclosed herein, participants may engage in richer and more efficient social interactions using avatars, by controlling a multiple-participant animation in coordination with a concurrent chat session. Participants may thereby enjoy an enhanced enjoyment of free-form game play in a VRU environment.

A VRU space provides animation of avatars within it. Two or more participants provide inputs to a common VRU process from a remote location to a central server, which aggregates the inputs to provide data for animating participating avatars in a space visible to the remote participants. Alternatively, such VRU process may be managed on a local or peer to peer basis. Animation processes may be performed at a central site, by peers in a peer to peer context, locally at each client using control data provided from a central server, or some combination of centrally, peer-generated, and locally. Viewing of resulting animated scenes may be performed by a client receiving aggregated scene data from a central server, or via a stream of data rendered remotely. Similarly, the server, or a cooperating chat server, or a peer to peer process, collects and distributes text chat data from and to each participant, such as in a chat window, to provide chat capability in parallel to a multi-participant animation. Animation may be implemented in a first window, and chat in a second window operating concurrently with the first window at each client.

Avatars in the animation may be provided with animation sequences or commands, for example, smile, frown, laugh, glare, looking bored, mouth agape, handshake, celebratory dance, and so forth, at appropriate times. Each avatar may be associated with a participant in the chat session. Chat text input by each user may be uploaded and parsed by the central server. Certain words or characters may be associated with different facial expressions. For example “LOL,” sometimes used in chat as an abbreviation for “laugh out loud,” may be associated with a “laughter” animation sequence for the avatar. Users need not memorize or type commands; they may cause avatars to respond to concurrent chat input, for example, by enabling an “automatic animation” feature and participating in a normal chat session while the feature is activated.

Similarly, the cadence and other characteristics of the user's interactions with the computer, such as typing speed or jumpiness of mouse movement, can be utilized in association with different body language and facial expressions. For example, if a user is typing very quickly, his avatar may have a more animated body stature and facial expression. Similarly, if a user interacts sluggishly with a keyboard, the corresponding avatar might look disinterested or tired.

In an embodiment, a system is provided for managing a multi-user animation process in coordination with a chat process. The system comprises a network interface for receiving chat data exchanged between remotely-located clients of an electronic chat process; a database comprising associations between defined data items in chat data and animation sequences; and a processor for parsing chat data received by the network interface. The processor identifies defined data items in chat data associated with a corresponding one of the clients that provided chat data in which the data item is located and selects animation sequences using the defined data items as selection criteria.

In accordance with one aspect of the embodiment, the system distributes output animation data to the clients based on the selected animation sequences for corresponding ones of a plurality of avatars associated with the corresponding ones of the clients. The output animation data may be any one or a combination of high-level command data, lower-level model data, and rendered low-level graphics data.

In accordance with another aspect of the embodiment, the chat data is any one or a combination of text data, audible data, video data, and graphics data. The processor may identify the defined data items in the chat data by using any one or a combination of Boolean, fuzzy, or other similar logic. In addition to or in place of chat data, the network interface may receive user command data from the remotely-located clients.

In accordance with a further aspect of the embodiment, the system may receive feedback data from the clients regarding the appropriateness of the associations between particular defined data items and animation sequences. In addition, or in the alternative, the defined data items may be prioritized and selected based on priority.

In another embodiment, a process is provided for managing a multi-user animation process in coordination with a chat process. The process comprises receiving input data items indicative of an emotional state of a remotely-located user of an electronic chat process; selecting animation sequences from a database of animation sequences using the input data items as selection criteria; and providing the animation sequences for corresponding ones of a plurality of avatars, wherein the animation sequences are associated with and reflect the emotional state of the corresponding ones of the users in a multi-user animation scene.

The input user data may be collected using one or more sensors associated with the user via an electronic interface. The input user data may be any one or a combination of the user's speech patterns, bodily movement, and physiological responses. The aspect of the user's speech patterns which are measured may include the volume, pace, pitch, word rate, inflections, or intonations. The user's physiological responses may include any one or a combination of user's skin temperature, pulse, respiration rate, or sexual response.

In accordance with another aspect of the embodiment, the user input data is the user's typing speed. The user's typing speed may be measured and compared with a rolling average of the user's typing speed to determine a normal, faster than normal or slower than normal typing speeds. The measured user's typing speed may be associated with different ones of the animation sequences.

In addition, a computer-readable medium may be provided, encoded with instructions operative to cause a computer to perform the steps of: parsing chat data exchanged between remotely-located participants of an electronic chat process to locate defined data items in chat data provided by the participants, each located data item associated with a corresponding one of the participants that provided chat data in which the data item is located; selecting animation sequences from a database of animation sequences using the defined data items as selection criteria; and providing the animation sequences for corresponding ones of a plurality of avatars associated with the corresponding ones of the participants in a scene of a multi-user animation process to produce a data output representative of the scene.

In addition, the instructions may be further operative to cause distributing the data output to at least one of the participants or to hosting the electronic chat process. Still further, the instructions may be operative to enable receiving the chat data from the participants and/or to cause distributing the chat data to the participants. The instructions may be further operative to cause storing associations between particular data items and particular animation sequences in the database and to enable receiving data from the participants indicating the associations between particular data items and particular animation sequences. The instructions may be further operative to enable defining the animation sequences, to cause adapting the animation sequences to individual avatar geometry, or to cause generating a sequence of animation frames expressing the animation sequences.

A more complete understanding of the method and system for managing a multiple-participant animation in coordination with a concurrent chat session will be afforded to those skilled in the art, as well as a realization of additional advantages and objects thereof, by a consideration of the following detailed description. Reference will be made to the appended sheets of drawings, which will first be described briefly.

### BRIEF DESCRIPTION OF THE DRAWINGS

FIG. 1 is a schematic diagram showing exemplary aspects of a system for hosting a multiple-participant animation in coordination with a concurrent chat session.

FIG. 2 is a schematic diagram showing a other exemplary aspects of system for controlling a multiple-participant animation in coordination with a concurrent chat session.

FIG. 3 is a schematic diagram showing other exemplary aspects of a system for controlling a multiple-participant animation in coordination with a concurrent chat session.

FIG. 4 is a schematic diagram illustrating other exemplary aspects of a system for controlling multi-participant animation in coordination with a concurrent chat session.

FIGS. 5A and B are charts showing exemplary data structures for use in selecting animation actions using chat data.

FIGS. 6 and 7 are flow charts showing exemplary steps of a method for controlling a multiple-participant animation in coordination with a concurrent chat session.

### DETAILED DESCRIPTION OF VARIOUS EMBODIMENTS

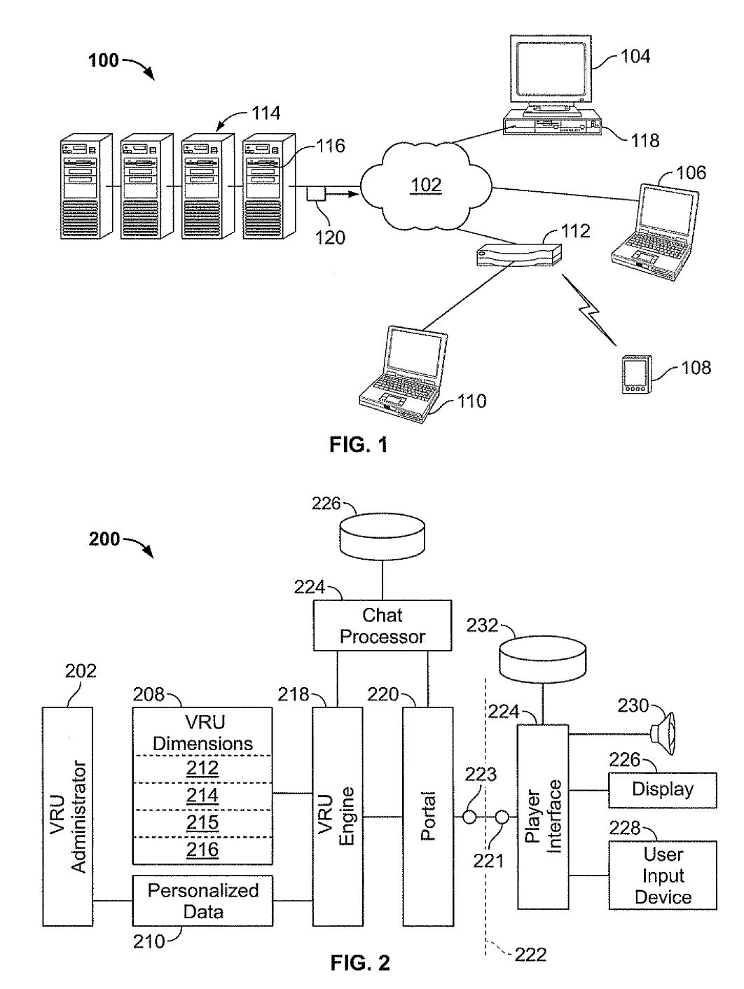

Referring to FIG. 1, a system 100 for providing a VRU to multiple users may comprise a plurality of client sites, nodes or terminals, for example a personal computer 104, portable computers 106, 110, a compact music, video or media player, cell phone or digital assistant 108, and/or router 112 communicating via a WAN 102 to one or more servers 114. Servers 114 store and serve VRU data and software to the client sites. Software or firmware may also be located at each client site, configured to work cooperatively with software or firmware operating on servers 114. Generally, any number of users may be communicating with servers 114 for participation in the VRU at any given time. Servers 114 and any or all of clients 104, 106, 108 and 110 may store executable code and data used in the performance of methods as described herein on a computer-readable media, such as, for example, a magnetic disk (116, 118), optical disk, electronic memory device, or other magnetic, optical, or electronic storage media. Software and data 120 for use in performing the method may be provided to any or all client devices via a suitable communication signal for network 102.

Referring to FIG. 2, a system 200 for providing a VRU process may be considered to be comprised of server-side components (to the left of dashed line 222) and client-side components (to the right of dashed line 222). Server-side components may comprise a portal 220 for managing connections to multiple simultaneous players. Portal 220 may interact with a VRU engine 218, passing user input 221 from multiple clients to the VRU engine, and passing data 223 from the VRU engine and chat processor 224 to respective individual players. VRU engine 218 may be operatively associated with various memory spaces, including environmental spaces 208 holding two or more separate VRU environments 212, 214, 215 and 216, and a personalized or common data space 210. As known in the art, objects in a VRU are modeled as three-dimensional objects, or two-dimensional objects, having a defined location, orientation, surface, surface texture, and other properties for graphic rendering or game behavior. Environmental memory space 208 may hold active or inactive instances of defined spaces used in the VRU environment. For example, the environment of a popular simulated nightclub, shopping area, beach, street, and so forth. Personalized space 210 may be comprised of various different personal areas each assigned to a different user, for example, avatar or avatar accessories data. The VRU engine may operate with other memory areas not shown in FIG. 2, for example various data libraries, archives, and records not inconsistent with the methods and systems disclosed herein. In addition, or in the alternative, portions or all of data maintained in memories 208, 210 may be maintained by individual clients at a local level.

Portal 220 may also interact with a chat processor 224, passing chat data from multiple clients to the chat processor, and session data from the chat processor to multiple clients. In the alternative, the chat processor may communicate directly with the multiple clients, or via a separate portal. The chat processor may further include functions for parsing chat data, associating chat data with animation sequences or commands, and communicating with the VRU engine 218. To associate chat data with animation sequences or commands, the chat processor may communicate with a database 226 or other data structure containing predetermined or learned associations between words, phrases, abbreviations, intonations, punctuations or other chat data and particular animation sequences or commands. Chat data may comprise text data, audible data, video data, graphics data, or any suitable combination of the foregoing. In some embodiments, chat data is primarily or completely comprised of text data. In other embodiments, chat data may include or be comprised primarily of non-text data. Whether or not it is comprised of text or other data, chat data as used herein means data that expresses a verbal (i.e., word-based), dialogue between multiple participants in a real-time or near real-time computing process.

Each user may customize an avatar to have an appearance and qualities specified by the user, by choosing avatar characters, features, clothing and/or accessories from an online catalog or store. The particular arrangement selected by a user may reside in a personalized space 210 associated with a particular user, specifying which avatar elements are to be drawn from a common space to construct an avatar. A customized avatar instance may be stored in a personalized space for the user. In the alternative, or in addition, a user may own customized elements of an avatar, including clothing, accessories, simulated physical powers, etc., that are stored solely in the personalized space and are not available to other users. Avatars may move and interact both with common elements and personalized elements.

A critical function of the VRU engine is to manage and aggregate input from multiple users, process that input to provide multi-participant animation scenes, and then prepare appropriate output data for animating or rendering scenes to be distributed to individual clients. To reduce system bandwidth requirements, it may be desirable to maximize processing that is performed at the client level. Accordingly, the VRU engine may process and prepare high-level scene data, while lower-level functions, such as animation and rendering, may be performed by an application residing at the client level. For example, the VRU engine may output object information to clients only when the object population of a scene changes, which is maintained locally during generation of a scene. While a scene is in progress, the VRU engine may provide high-level time-dependent data, such as animation commands, in a chronological sequence. Local clients may operate on the high-level aggregate scene data received from the VRU engine to animate and render a scene according to a viewpoint determined or selected for the local client. Functions may be distributed in any desired fashion between a central server and local clients. It is conceivable that functions of the VRU engine may be distributed among a plurality of local clients to provide a peer-to-peer implementation of the multi-participant animation system. However distributed between participating clients and a host, the essential aggregating and coordinating functions of the VRU engine should be performed at a suitable node or nodes of the system.

A separate administration module 202 may operate at the server level to create, update, modify or otherwise control the content of the VRU as defined in the memory areas 208 and 210. Generally, changes in the personal space area 210 are driven by individual users, either through the VRU administrator 202 or another module. Control of common areas, i.e., the game environment and the objects in it, including any multi-dimensional areas, may be via the administrator module 202.

At the client level, a player interface module 224 may be installed to receive player inputs from one or more user input devices 228, such as a keyboard, mouse or other pointer, or microphone, and provide data to the VRU engine 218 via portal 222 in response to the input. The player interface module may also receive game data from portal 220 and process the data for display on display 226 and/or for audio output on speaker 230. Animation data, environmental data, chat data, executable code or any combination of the foregoing may be stored in a local memory 232.

Various systems and methods for providing a three-dimensional, multiplayer interactive animation to multiple players are known in the art, or may be adapted by one of ordinary skill for use with technology described herein. For example, rendering of a scene may be performed at the client or server level. Generally, it may be advantageous to perform calculations and graphics operations, to the extent possible, at the client level, thereby freeing up network bandwidth and minimizing loads on the server. Implementation of the embodiments described herein is not limited to a particular hardware or software architecture.

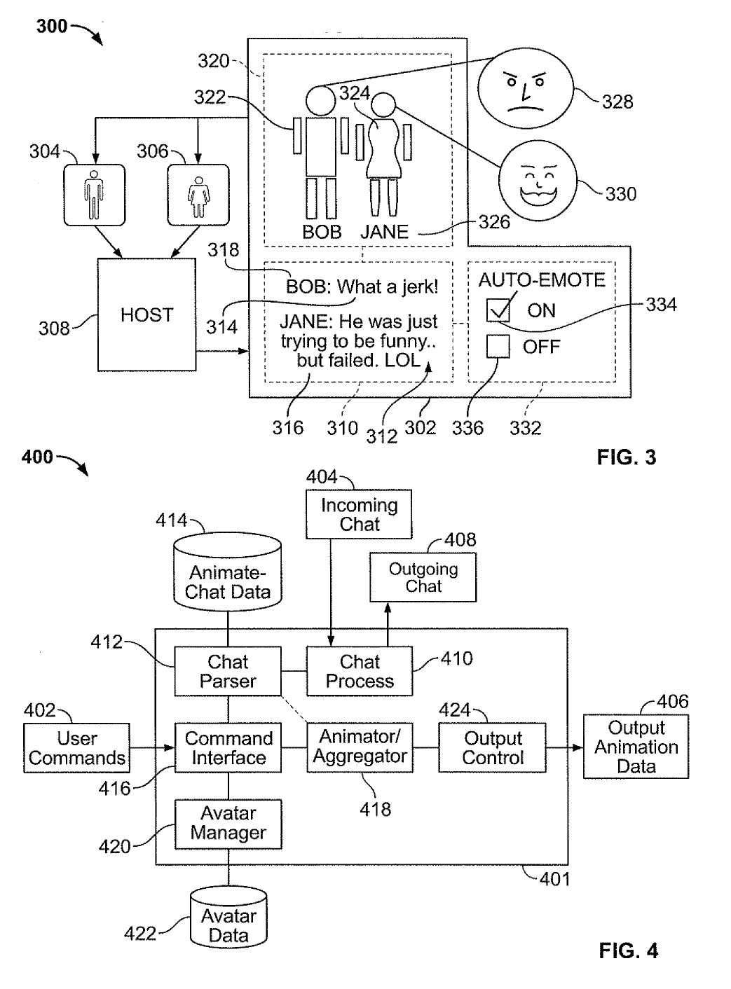

FIG. 3 shows in schematic, simplified fashion a system 300 for providing a multi-user animation in coordination with a chat process, including an exemplary interface 302 that includes chat data and animation output. Interface 302 represents information that may be available to and viewed by multiple participants, for example, a first client 304 “Bob” and a second client 306 “Jane” communicating with each other via a host 308.

Interface data 302 may comprise a chat window 310 containing chat data 312 received in a chat session. Chat data 312 may comprise first text 314 received from “Bob” 304 and second text 316 received from “Jane.” Any number of participants may provide text data to the chat session, with each contributed block of text labeled with an identifier 318 for its contributor. Blocks of text may be placed in chronological order and scrolled in the chat window 310. Further details of chat sessions as known in the art should be apparent to one of ordinary skill, and may be applied for use with the embodiments described herein.

Interface data 302 may further comprise an animation scene window 302, in which rendered animated avatars 322, 324 corresponding to participants 304, 306 in the chat session may appear. Each avatar may be labeled with an identifier for its controlling user. For example, the avatar 324 is labeled with the identifier 326 “JANE,” indicating that the avatar is controlled by the second client 306. Host 308, clients 304, 306, or both hosts and clients, may receive command data and process the command data to cause animation and movement of each client's avatars within the modeled scene 320. For example, by providing defined input through a command interface (not shown), an operator of client 304 may cause the avatar 322 to walk left, and so forth.

Avatars 322, 324 may be modeled as jointed articulated figures capable of predetermined movements or animation sequences, for example, walking, standing, sitting, reaching, grasping, and so forth. In addition, each avatar's face may include moveable elements that may be similarly animated, for example, eyes, eyebrows, mouth, cheeks, and so forth. A VRU engine or local client may contain information about sets of facial movement that, when executed together, cause an avatar to exhibit a defined facial expression. Avatar body movement may also be correlated to facial expression or movement. For example, FIG. 3 shows an enlarged view of a face 328 belonging to avatar 322, showing an angry expression, and a face 330 belonging to avatar 324 that is laughing. Control of avatar facial expression may be accomplished using an animation control interface, as known in the art. In addition, or in the alternative, control of facial expression or other avatar actions may be determined automatically from a concurrent chat session 310.

Use of chat input for animation control may be turned on or off using a toolbar, window 332 or other user input device. For example, window 332 employs radio buttons 334, 336 that may be selected or deselected to turn an “auto-emote” feature on or off. While the term “auto-emote” is used in FIG. 3, it should be appreciated that use of concurrent chat text to animate avatars in a multi-participant online scene is not limited to generating facial expressions or expressing emotions. Nonetheless, automatically generating facial expressions or otherwise expressing emotions that may be discerned from chat text or other chat input (e.g., audible or graphical input) is an important and useful feature of the technology described herein.

Animation and facial expressions appearing in scene window 320 may be coordinated with contents of chat session 310. For example, after user “Bob” provides chat input data “What a jerk!” with the auto-emote feature on, his avatar 322 may adopt an angry expression 328. The selected expression may be maintained for a defined period, or maintained until further command or chat input is received from “Bob,” or some combination of the foregoing. For example, angry expressions may be relaxed to a neutral expression after some period of time, unless input indicating the same or a different expression is input by the user. Likewise, after user “Jane” provides the chat input data “funny” and “LOL,” her avatar 324 may adopt a laughing expression. Coordination of animation in a scene window 320 with chat data in a chat session may be performed using the systems and methods described herein.

Likewise, typing speed in a chat session may be measured and correlated with emotional expressions on avatars. For example, an application on the client may measure a rolling average rate of keystrokes, and periodically report a quantitative or qualitative speed indicator to the host. The host may then use this indicator by itself, or more preferably, in combination with other input, to select a corresponding facial expression for the client's avatar. Tired, bored, or drowsy expressions may be selected for slow typing speeds, while normal or more animated expression may correlate to higher typing speeds. To compensate for differences between individual typing abilities, the client speed-measuring module, or a host function, may compare a current rolling average of typing speed to a longer-term rolling average to obtain a measure of speed relative to a baseline, such as “normal”, “faster than normal” or “slower than normal,” where “normal” is a speed equal to the longer-term average.

These inventive concepts may be extended to other forms of input, as well. For example, in an audio chat session, a voice analyzer may process spoken input to measure factors such as, for example, relative volume, pace, pitch, word rate, or other factors that may be correlated to emotional states. As with typing speed, such measures may be compared with long-term speech patterns for each individual user to obtain relative measures. Relative or absolute measures may be input into an emotion-selection module at the host or client level to automatically select a facial expression and/or body movement that correlates to the measured factors. Optionally, the client may override automatic selections using a manual emotive indicator, some examples of which are described herein.

Non-chat data related to the emotional state of the user operating a client may be collected using sensors connected to the user via an electronic interface box. Motion sensors may be used in a similar fashion to detect bodily movement. Other factors that may be measured include skin temperature, pulse, respiration rate, or sexual response. Measured data indicative of such responses may be processed to select emotional states, including sexual response states, of the user operating a remote client. These correlated states may then be animated and rendered in the avatar operated by the remote client.

FIG. 4 shows other exemplary aspects of a host system 400 for controlling multi-participant animation in coordination with a concurrent chat session. System 400 receives incoming user commands 402 and incoming chat data 404, and outputs animation data 406 in coordination with a chat session. Animation data 406 may comprise high-level command data, lower-level model data, rendered low-level graphics data, or any suitable combination of the foregoing. Data 406 is provided to multiple remote clients, configured to cause the remote clients to output a VRU scene with avatars animated according to the incoming chat data 404 and separate user command data 402. Host system 400 may also provide outgoing chat data 408 comprising an aggregation of incoming chat data 404 organized into chat sessions by a chat process 410.

Certain processes shown in FIG. 4 are located in a host 401. The host 401 may comprise a single machine, running processes using separate software, firmware, or both. Various processes and functions of host 401 may be implemented using an object-oriented architecture. For scalability, software and firmware used to implement functions of host 401 may be designed to run on different physical machines connected via any suitable network. Any processes or functions described as part of host 401 may be implemented in a single machine, or distributed across a plurality of locally-connected or remotely-connected servers. Host 401 may also include other processes and functions that are not described herein, but that should be apparent to one of ordinary skill for implementing the described system.

A chat parser process 412 may operate in cooperation with the chat process 410 to locate animation sequences, animation commands, or other identifiers for animation sequences that are associated or indicated by chat data. Optionally, each user may deactivate operation of the chat parser using a user interface or command.

Animation sequences may be generally described as numeric time-related data indicating position or movement of defined nodes (e.g., joints, segments, and so forth) of an articulated system. Such sequences should be generic so as to be applicable to any model having nodes that can be mapped to nodes used by the animation sequence. For example, a “smile” sequence may be applied to any avatar having face nodes capable of being related (mapped) to nodes of the sequence, to cause avatars with differently-shaped faces to smile. Such principles are known in computer animation of human-based models, and need not be described in detail here. An animation engine may use a library of generic animation sequences that can be applied to different avatars or portions of avatars. For example, some animation sequences may apply to face models only. Animation sequences may be distributed to client-side memory and applied locally, applied at the host, or applied using some combination of the host and client.

Animation sequences may be identified using any suitable code or identifier, each of which may uniquely identify a single animation sequence retained in a memory at a host or client level. In addition, or in the alternative, animation sequences may be identified by user commands or command data received from a user interface module. However, command data is usually considered high-level control information, and advantages that will be understood by one of ordinary skill may accrue from using an intervening lower-level identifier for each animation sequence, and not relying solely on command data to identify an animation sequence. For example, it may be desirable to apply different animation sequences for different avatars, in response to identical commands from different users.

Chat parser 412 may be configured to perform different functions, including a first function of identifying words, phrases, abbreviations, intonations, punctuation, or other chat data indicative of a proscribed automated animated response. In some implementations, the parser 412 may parse incoming text data to identify the occurrence of key words, phrases, non-verbal character combinations, or any other character strings that are defined in a database 414 or other suitable data structure as associated with an animation command or low-level identifier for an animation sequence. The identifying function may use fuzzy logic to identify key words or phrases as known for language filtering in chat and other editing applications, or may require an exact match. The identifying function may, in addition or in the alternative, receive user feedback regarding the appropriateness of keyword or phrase selections and use an artificial intelligence process to improve its selection process and select chat data that more closely match user intentions, while ignoring extraneous data. Generally, selected textual data may be regarded as indicative of an emotional state or idea that is, is the natural world, often expressed by a facial expression or other bodily movement. Avatar actions, for example laughing, leaping for joy, clenching a fist or other gestures may also be indicated and automatically selected.

The chat parser 412 is not limited to parsing text data. For example, if chat data includes an audio signal such as recorded speech, the signal may be analyzed using a speech-to-text converter followed by textual analysis. Also, speech patterns may be analyzed to detect inflections and intonations indicative of a particular emotion or expression to be conveyed by an avatar animated action. Methods and systems as disclosed herein are not limited processing of input to typed text or speech. In addition, or in the alternative to parsing of chat data, other input, such as user movement or bodily response from physical sensors may be processed to select an emotional state, using an analogous software process.

Accordingly, the chat parser or analogous process operates to detect any suitable chat data or other collected input that is indicative of a particular emotion, expression or sexual state or arousal to be conveyed by an avatar using an animated facial expression or other animated action, including bodily movement of the avatar. Detection of chat data may vary based on a user profile or user preferences for the user submitting the incoming chat 404, or may be the same for all users. For example, a user's native language, age, region, consumer tastes, and so forth, may provide clues for identifying chat data to be used for selection of character animation sequences.

In conjunction with identifying indicative chat data, the chat parser 412 or analogous process may perform a second function of selecting an identifier for an animation sequence, or an animation command, based on characteristics of detected chat data. The chat parser may use database 414, which may store associations between particular chat data or classes of chat data and particular animation commands or sequence identifiers. Associations between detected chat data and animation commands or sequence identifiers may vary based on a user profile or user preference for the user submitting the chat data. In the alternative, such associations may be the same for all users submitting chat data. Although the chat parser may associate sequence identifiers with chat data, it may generally be more advantageous to associate high-level animation commands with chat data. Database 414 may be developed using a manual administrative process, automatically using user feedback in a programmed learning process, or any suitable combination of manual and automatic operations. User feedback regarding the appropriateness of associations between selected chat data and animated actions or expressions may be received, and used in an artificial intelligence process to improve selection of animation sequences so as to more closely satisfy user expectations.

The chat parser 412 or analogous process may provide animation commands or identifiers for animation sequences to a command interface process 416. In the alternative, the parser may provide a command stream directly to an animation and aggregation process 418. Each command stream or other output data specifying animation actions to be performed by an avatar should be associated with an avatar to whom the commands or other data relate.

The command process interface 416 functions to receive user commands 402 from multiple remote clients for directing animation of avatars. The command interface 416 may also communicate with an avatar management process 420, which may use stored avatar data 422 to determine whether or not a user-specified command can appropriately be executed in view of constraints applicable at the time the command is received. Constraints may include limitations imposed by the nature of the avatar—avatars may not be capable of responding to all commands—or the environment the avatar is in, which may interfere with or prohibit certain actions. Filtered and/or processed user commands may then be passed to the animation and aggregation process 418, which may receive a command stream (or streams) each associated with a particular avatar. The command interface 416 may therefore perform a process of integrating separate command streams to provide a single command stream for each avatar. Integration may include prioritization and selection of commands based on priority, adding animation sequences together, spacing initiation of animation sequences at appropriate intervals, or combinations of the foregoing.

The animation and aggregation process 418 may function to receive animation command streams originating from the different command input processes 412, 416, and process the streams for output to remote system clients. The type of processing performed by the aggregator 418 depends on details of the system; for example, whether or not client systems are configured to receive high-level command data, or lower level data. One process that is essential to proper functioning of the system 400 is to group command streams or command sets for avatars in common environments. The aggregator should therefore have access to data concerning the location of each avatar for which command data is received. For example, such data may include avatar coordinates and optionally, information regarding boundaries of environments or areas in the VRU. Various methods may be used to group command data, for example, command data may be grouped into sets for each avatar—‘n’ sets may be generated for ‘n’ centrally-located avatars, including command data for avatars that are located within a defined distance from the central avatar, and excluding data for more distant avatars.

The host animation process 418 may also perform selection of identifiers for animation sequences, retrieving animation sequences, or both, based on incoming command data, avatar data, and environmental rules or states of the avatar environment. In the alternative, these steps may be performed at the client level, with the host process 418 operating on command data only. In addition, process 418 may apply selected animation sequences to avatar model data to prepare output data for every frame, or key frames, of an action sequence. Again, these steps may, in the alternative, be performed at individual clients based on command or sequence data from a host.

An output control process 424 may be used to direct and control output animation data 406 to each client at appropriate intervals. The control process may provide data at uniform rates to each client while maintaining synchronicity between data streams. Output data rate may be varied based on an estimated or measured transmission time to each client. The control process may also configure or format the output data so that it is usable to each local client.

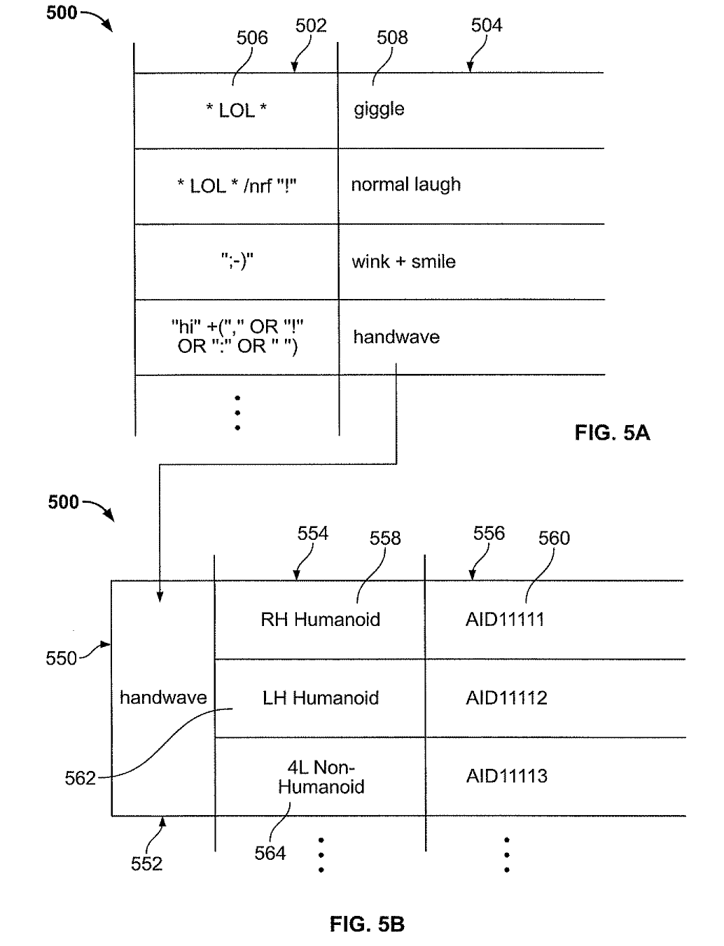

FIG. 5A shows an exemplary data table 500 for relating chat data 502 to animation command data 504, such as may used by during a chat parsing process as described above. Entries in the first column 502 describing chat data correspond to entries in the second column 504 describing various animation commands. A first exemplary entry 506 shows chat data “LOL” related to a “giggle” animation command 508. A second entry shows that an “LOL” located near an exclamation mark relates to a normal laugh action. Whether or not two items are near may be determined using fuzzy logic. A third entry shows “;-)” related to two simultaneous actions: a wink and a smile. And a fourth entry shows that “hi” with various marks or a trailing space is related to a hand waving action.

FIG. 5B shows an exemplary second table 550 such as may be used at a parser or downstream process to select a particular animation sequence for a given animation command, using at least one additional selection criteria. In this example, a first column 552 contains an animation command entry “handwave” that spans three rows of the data table. A second column 554 contains entries for a second criteria, in this example an avatar type. A third column 504 contains entries for identifiers or pointers to different animation sequences. A first entry 558 indicates a “right-handed humanoid” avatar type. For a “handwave” command, an animation sequence identified by the first entry 560 in the third column 556 may be selected. Likewise, a different sequence may be selected for an avatar type of “left-handed humanoid” in the second row. For a third avatar type “four-legged humanoid,” a third animation sequence may be selected. FIG. 5B merely exemplifies how data associations such as shown may be used to allow common animation commands to specify different animation sequences, depending on character types or other factors.

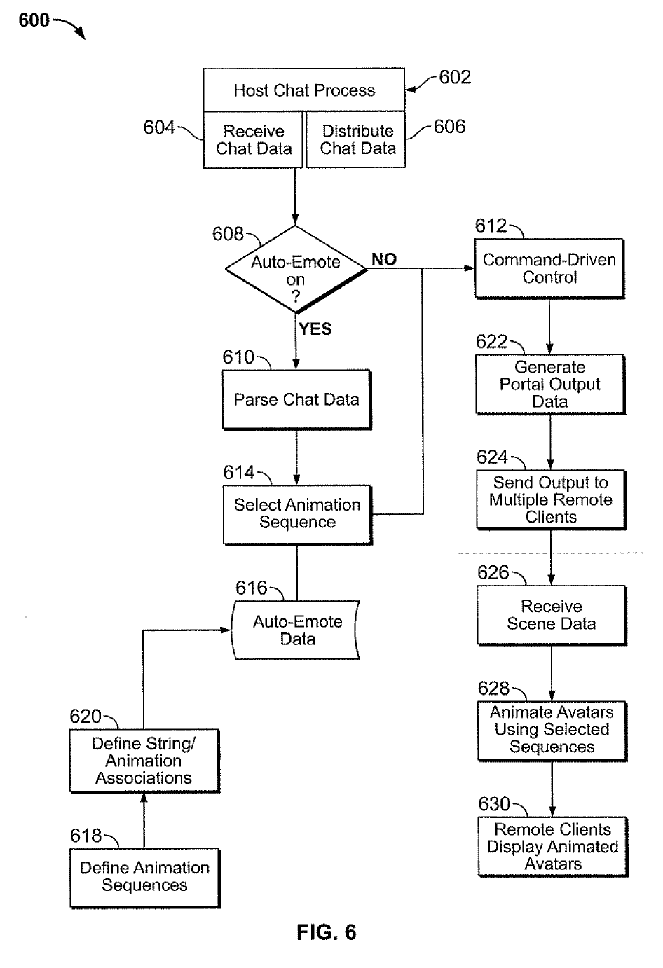

FIG. 6 shows exemplary steps of a method 600 for controlling a multiple-participant animation in coordination with a concurrent chat session conducted by a host chat process 602. The chat process 602 may include a step of receiving chat data 604, aggregating the data, and distributing the aggregated chat data 606 to participants in the session. Participants in the chat session may each also be operating an avatar in a multiplayer remote animation process, such as in a VRU. If an “auto-emote” or auto-animation feature is enabled 608, chat data received at step 604 may be parsed 610 to identify indicators of expressive content to be animated. At step 614, animation sequence data may be selected using chat-animation associations stored in an appropriate data structure 616. If no auto-automate feature is enabled 608, chat data is not parsed and user commands are used to direct character animation according to a command-driven control process 612.

The chat-animation association data 616 may be developed and maintained in an asynchronous process that includes an initial step of defining animation sequences 618 for modeled characters, i.e., avatars, in the VRU environment. Core animation sequences may be developed manually by a skilled animator, collected from measured data for human models, or some combination of the foregoing. Variations on core sequences may be created by scaling or otherwise modifying control parameters used to define an animation sequence. Completed sequences may be assigned an identifier and stored in a suitable data structure at a host level, client level, or both.

In addition, associations between various animation sequences and character strings or classes of chat data may be defined at step 620, independently and asynchronously with operation of a VRU. A database of association data may be populated initially by a manual administrative process, and maintained and updated to refine appropriate character responses to chat data. Refinement may be performed using an AI process supplied with user feedback regarding the appropriateness of character actions. Associations may be personalized for each user, generic for all users, or some combination of personalized and generic.

After animation sequences are identified and selected at step 616, corresponding command data may be supplied to a command driven control process 612. Command data from step 616 may be in addition to, or instead of, user command data provided via a command interface. The command-driven control process 612 may receive separate command streams originating from chat parsing 610 or user interface control, and combine them as appropriate for the modeled VRU environment.

Portal output data may then be generated at step 622. In step 622, clients to a VRU process may be tracked and control data output from the control process 612 may be formatted, segregated and packaged for each client according to a defined data protocol. At step 624, the output data may be transmitted to the remote clients, for example using an Internet Protocol transmission to an open port on each client machine. At step 626, each client may receive transmitted data representing a commanded or generated state of the VRU. If not already performed at the host level, the client may apply specified animation sequences to avatars present in the scene being modeled. At step 628, each client may animate and render avatars present in the scene according to the received scene control data. In the alternative, step 628 may be performed at a host level, in which case low-level scene data would be received at step 626.

At step 630, rendered scene data may be presented on an output device of each client, for example on a display monitor or screen. Rendered output may be formatted as video output depicting each visible avatar in the scene, which is animated according to commands determined from chat data and optionally from user-specified commands. Concurrently, the distributed chat data 606 may also be displayed on the output device. Characters in the scene may appear to express emotions and concepts from the accompanying chat session in their animated actions and expressions. The foregoing steps are merely exemplary, and other steps may be suitable for achieving the results herein described.

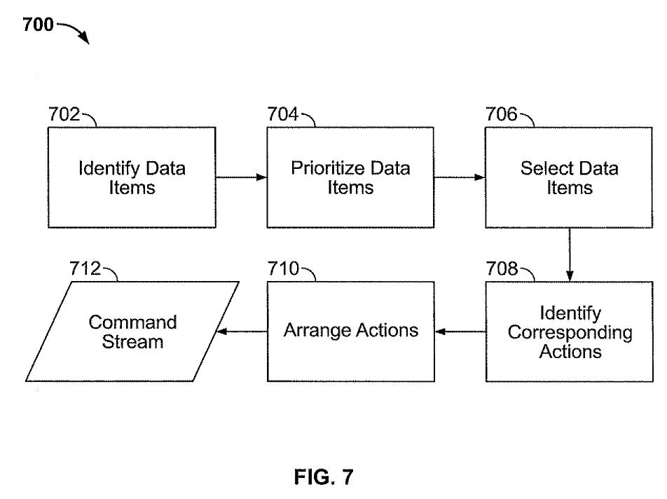

FIG. 7 shows exemplary steps of a process 700 for generating an animation command stream 712 by parsing incoming chat data. Process 700 depicts in more detail exemplary steps as may be subsumed in steps 610 and 614 of method 600, in some embodiments. At step 702, a parser may receive incoming chat data and identify data items in the chat data that are associated with animation actions. For example, the chat stream may be filtered or searched to identify data items meeting predefined criteria, using Boolean logic, fuzzy logic, or other approach. Data items may comprise, for example, character strings meeting the defined search criteria, or in spoken data, a value or quality of intonation detecting in a spoken phrase.

At step 704, any data items discovered in step 702 may be prioritized. Various different rules may be used to prioritize data items. For example, priority may be given based on which item is first, in a “first come first served” system. Later items may be given priority based on an assumed animation period and the number of competing data items competing for the same period. If there is not enough time to perform to competing actions, the action later in time may be omitted. Competing actions may be actions that cannot be performed simultaneously without altering each other, such as a smile and a frown. Other actions may not affect one another and may be considered non-competing, such as a smile and a hand wave. Data items indicating non-competing actions may be given equal priority. Other prioritization criteria may be applied, instead of or in addition to time. For example, a data item indicating a smile might be always given greater priority than a frown. Still another approach is to perform no prioritization, and instead initiate all indicated sequences when indicated by addition. Of course, this may result in overlapping of competing actions, which may in turn cause unpredictable or unnatural behavior in the animated avatars.

At step 706, data items may be selected based on priority. This may result in some data items being discarded. At step 708, actions corresponding to the remaining data items may be identified, so as to allow the indicated actions to be placed in an appropriate order and pace. Step 708 may also be performed earlier so that information concerning indicated actions may be available in the prioritization process. At step 710, the indicated actions may be arranged as determined by the chat data and other factors. For example, if a handwave is indicated in the same block of chat data as a smile, both actions might be selected to be initiated at the same time, although they may last for different durations. Other actions, such as competing actions, may be spaced apart by a period of time. For example, if a smile and a frown were both indicated in a block of chat data, the smile may be performed, then the avatar may relax her expression to neutral for a defined period, then the frown may be performed until it, too, is relaxed to a neutral expression. Once the order and pacing of the indicated actions is determined, an appropriate command stream 712 for causing the avatars to react as arranged may be output to the downstream process. A great variety of possibilities exist for different ways of prioritizing data items and arranging indicated actions to create a command stream.

Having thus described embodiments of method and system for controlling a multiple-participant animation in coordination with a concurrent chat session, it should be apparent to those skilled in the art that certain advantages of the within system have been achieved. It should also be appreciated that various modifications, adaptations, and alternative embodiments thereof may be made within the scope and spirit of the present invention. For example, a method implemented using textual chat data has been illustrated, but the inventive concepts described above would be equally applicable to implementations with other types of chat data.

What is claimed is:

1. A system for managing a multi-user animation process in coordination with a chat process, comprising:
a network interface disposed to receive chat data from remotely-located clients of an electronic chat process;
a database comprising associations between defined data items in chat data and animation sequences;
a memory holding program instructions operable for parsing chat data received by the network interface, identifying defined data items in chat data associated with a corresponding one of the clients that provided chat data in which the data item is located, and selecting animation sequences using the defined data items as selection criteria; and
a processor, in communication with the memory, the database, and the network interface, configured for operating the program instructions.

2. The system of claim 1, wherein the program instructions are further operable for providing output animation data to the clients based on the selected animation sequences for corresponding ones of a plurality of avatars associated with the corresponding ones of the clients.

3. The system of claim 2, wherein the output animation data is any one or a combination of high-level command data, lower-level model data, and rendered low-level graphics data.

4. The system of claim 1, wherein the chat data is any one or a combination of text data, audible data, video data, and graphics data.

5. The system of claim 4, wherein the program instructions are further operable for identifying defined data items in the chat data using any one or a combination of Boolean logic or fuzzy logic.

6. The system of claim 1, wherein the network interface additionally receives user command data identifying animation sequences from remotely-located clients.

7. The system of claim 1, wherein the system receives feedback data from the clients regarding the appropriateness of the associations between particular defined data items and animation sequences.

8. The system of claim 1, wherein the program instructions are further operable for prioritizing and selecting the defined data items based on priority.

9. A process for managing a multi-user animation process in coordination with a chat process, comprising:
receiving input data items indicative of emotional states of remotely-located users of an electronic chat process from a plurality of clients;
selecting animation sequences from a database of animation sequences using the input data items as selection criteria; and
providing the animation sequences for corresponding ones of a plurality of avatars to the plurality of clients, wherein the animation sequences are associated with and reflect emotional states of corresponding ones of the users in a multi-user animation process indicated by the data items.

10. The process of claim 9, wherein the input user data is collected using one or more sensors associated with the user via an electronic interface.

11. The process of claim 10, wherein the input user data is any one or a combination of the user's speech patterns, bodily movement, and physiological responses.

12. The process of claim 11, wherein the user's speech pattern includes any one or a combination of volume, pace, pitch, word rate, inflections, or intonations

13. The process of claim 11, wherein the user's physiological responses includes any one or a combination of user's skin temperature, pulse, or respiration rate.

14. The process of claim 9, wherein the user input data comprises the user's typing speed.

15. The process of claim 14 further comprising measuring the user's typing speed and comparing the user's measured typing speed with a rolling average typing speed to determine a normal, faster than normal or slower than normal typing speeds.

16. The process of claim 15, wherein the typing speed is associated with different ones of the animation sequences.

17. Computer-readable media encoded with instructions operative to cause a computer to perform the steps of:
parsing chat data exchanged between remotely-located participants of an electronic chat process to locate defined data items in chat data provided by the participants, each located data item associated with a corresponding one of the participants that provided chat data in which the data item is located;
selecting animation sequences from a database of animation sequences using the defined data items as selection criteria; and
providing the animation sequences for corresponding ones of a plurality of avatars associated with the corresponding ones of the participants in a scene of a multi-user animation process to produce a data output representative of the scene.

18. The computer-readable media of claim 17, wherein the instructions are further operative to cause distributing the data output to at least one of the participants.

19. The computer-readable media of claim 17, wherein the instructions are further operative to cause hosting the electronic chat process.

20. The computer-readable media of claim 17, wherein the instructions are further operative to enable receiving the chat data from the participants.

21. The computer-readable media of claim 20, wherein the instructions are further operative to cause distributing the chat data to the participants.

22. The computer-readable media of claim 17, wherein the instructions are further operative to cause storing associations between particular data items and particular animation sequences in the database.

23. The computer-readable media of claim 22, wherein the instructions are further operative to enable receiving data from the participants indicating the associations between particular data items and particular animation sequences.

24. The computer-readable media of claim 17, wherein the instructions are further operative to enable defining the animation sequences.

25. The computer-readable media of claim 17, wherein the instructions are further operative to cause adapting the animation sequences to individual avatar geometry.

26. The computer-readable media of claim 17, wherein the instructions are further operative to cause generating a sequence of animation frames expressing the animation sequences.
